(19) United States
(12) Patent Application Publication
(10) Pub. No.: US 2009/0116246 A1
(43) Pub. Date: May 7, 2009

(54) Back Light Module

(75) Inventors: Ren-Sheng Lu, Xiamen (CN); Wei Ren, Xiamen (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: AU OPTRONICS (XIAMEN) CORP., Xiamen (CN); AU OPTRONICS CORPORATION, Hsin-Chu (TW)

(21) Appl. No.: 12/122,214

(22) Filed: May 16, 2008

(30) Foreign Application Priority Data
Nov. 1, 2007 (CN) 200710167203.X

(51) Int. Cl. F21V 17/00

(52) U.S. Cl. 362/317

(57) ABSTRACT

The back light unit disclosed includes an optical film with at least one side, two breaches formed on the least one side with different heights respectively, a frame with a fillister for containing the optical film, and two blocks disposed in the fillister. The blocks are disposed corresponding to the breaches respectively. The blocks are located in the breaches when the optical film is fixed in the fillister.

### RELATED APPLICATIONS

This application claims priority to China Application Serial Number 200710167203.X, filed Nov. 1, 2007, which is herein incorporated by reference.

### BACKGROUND

1. Field of Invention

The present invention relates to a back light unit. More particularly, the present invention relates to the optical film and frame of the back light unit.

2. Description of Related Art

Recently, liquid crystal displays (LCD) have been widely applied in electrical products, due to the rapid progress of optical technology and semiconductor technology. Moreover, with the advantages of high image quality, compact size, light weight, low driving voltage, and low power consumption, LCDs have been introduced into portable computers, personal digital assistants, color televisions, and are gradually replacing the cathode ray tubes (CRT) used in conventional displays. LCDs have become the mainstream display apparatus.

A conventional back light type LCD comprises a front-end liquid crystal panel and a back-end back light module. Therefore, a large back light module is required for providing enough illumination to pass through the liquid crystal layer to show the information on the LCD.

The conventional back light module may include a back light source, a frame, and an optical film, such as a light guide plate, a reflector, a diffuser, or a prism sheet. The optical film is difficult to recognize the front side and the back side with naked eyes, thus the optical film might be placed upside-down when the optical film is assembled, and the efficiency of the back light unit would be reduced.

JP 2004354807 has disclosed a back light unit for the LCD module. The optical film of the back light unit in this application has a plurality of salients extended from opposite sides of the optical film, and the frame of the back light unit has a plurality of breaches disposed corresponding to the salients. The optical film must be assembled correctly by coupling the salients with the breaches when the optical film is assembled in the frame.

However, a large size optical film is required in this application to fix the optical film in the frame firmly. The unnecessary part of the large size optical film is cut to form the normal size optical film with the salients extended, and the original size optical film can be fixed in the frame firmly. The unnecessary part cut from the large size optical film would be wasted and generates a higher material cost.

For the forgoing reasons, there is a need for prevent the optical film assemble upside-down and would not generate higher material cost.

### SUMMARY

The present invention is directed to a back light unit, that satisfies this need for preventing the optical film from upside down assembly.

The back light unit of the invention includes an optical film with at least one side, two breaches formed on the least one side with different heights respectively, a frame with a fillister for containing the optical film, and two blocks disposed in the fillister. The blocks are disposed corresponding to the breaches respectively. The blocks are located in the breaches when the optical film is fixed in the fillister.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a side view diagram of an embodiment of the back light unit of the invention;

FIG. 1B is a top view diagram of the embodiment of the back light unit of the invention;

FIG. 2A to FIG. 2D are the schematic diagrams of different embodiments of the back light unit of the invention; and

FIG. 3A to FIG. 3C are the schematic diagrams of different embodiments of the optical film of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The conventional back light module may include a back light source, a frame, and an optical film, such as a light guide plate, a reflector, a diffuser, or a prism sheet. The optical film may be side inserted into the fillister of the frame when the back light unit is assembled. However, recognizing the front side and the back side of the optical film with the naked eye is difficult, thus the optical film might be placed upside-down when the optical film is assembled, and the efficiency of the back light unit would be reduced.

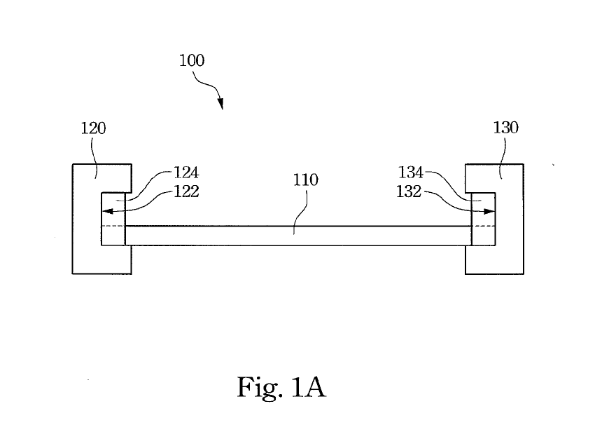

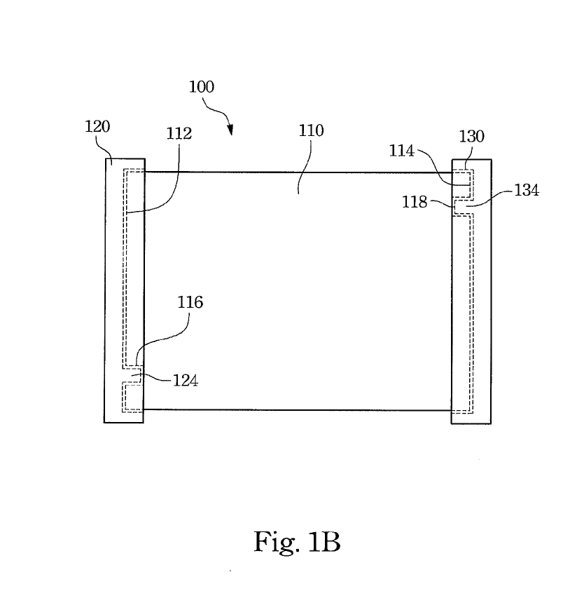

Refer to FIG. 1A and FIG. 1B simultaneously. FIG. 1A and FIG. 1B illustrate a side view diagram and a top view diagram of an embodiment of the back light unit of the invention. The back light unit 100 includes an optical film 110, a first side frame 120, and a second side frame 130. The optical film 110 has a first side 112, and a second side 114 opposite to the first side 112. The back light unit 100 includes a first breach 116 disposed on the first side 112, and a second breach 118 disposed on the second side 114. The first breach 116 and the second breach 118 are disposed at different height respectively. The first side frame 120 and the second side frame 130 include a first fillister 122 and a second fillister 132 respectively. The back light unit 100 includes a first block 124 disposed in the first fillister 122, and the first block 124 is disposed corresponding to the first breach 116. The back light unit 100 includes a second block 134 disposed in the second fillister 132, and the second block 134 is disposed corresponding to the second breach 118. The first block 124 and the second block 134 are disposed in the first breach 116 and the second breach 118 respectively when the optical film 110 is fixed in the first fillister 122 and the second fillister 132.

The first breach 116 and the second breach 118 are arranged at different height respectively. The first block 124 and the second block 134 are arranged at different height respectively. The first block 124 and the second block 134 interfere with the first side 112 and the second side 114 of the optical film 110, and the optical film 110 would bend if the optical film 110 were assembled upside down. Thus the optical film 110 could not be assembled in the first side frame 120 and the second side frame 130 properly, and this mistake can be detected with the naked eye and further be corrected.

The first side frame 120 and the second side frame 130 are independent devices in this embodiment, but the first side frame 120 and the second side frame 130 may also be the side portions of a rectangular frame. The shape of the breaches 216, 218 and the blocks 224, 234 may be selected from the group consisting of a triangle, a rectangle, an arc, a polygon, and the combination thereof.

The back light unit 100 may take the first breach 116, the second breach 118, the first block 124, and the second block 134 to be the position structure. The first block 124 and the second block 134 are dispose in the first fillister 122 of the first side frame 120 and the second fillister 132 of the second side frame 130 respectively. The first breach 116 and the second breach 118 are formed on the edge of the optical film 110, which is regarded as the not-display area of the optical film 110. Even though the first breach 116 and the second breach 118 are formed on the first side 112 and the second side 114 of the optical film, the main portion of the first side 112 and the second side 114 can still locate in the first fillister 122 and the second fillister 132. Thus the optical film 110 can still be fixed in the first frame 120 and the second frame 130 firmly and would not generate additional material cost.

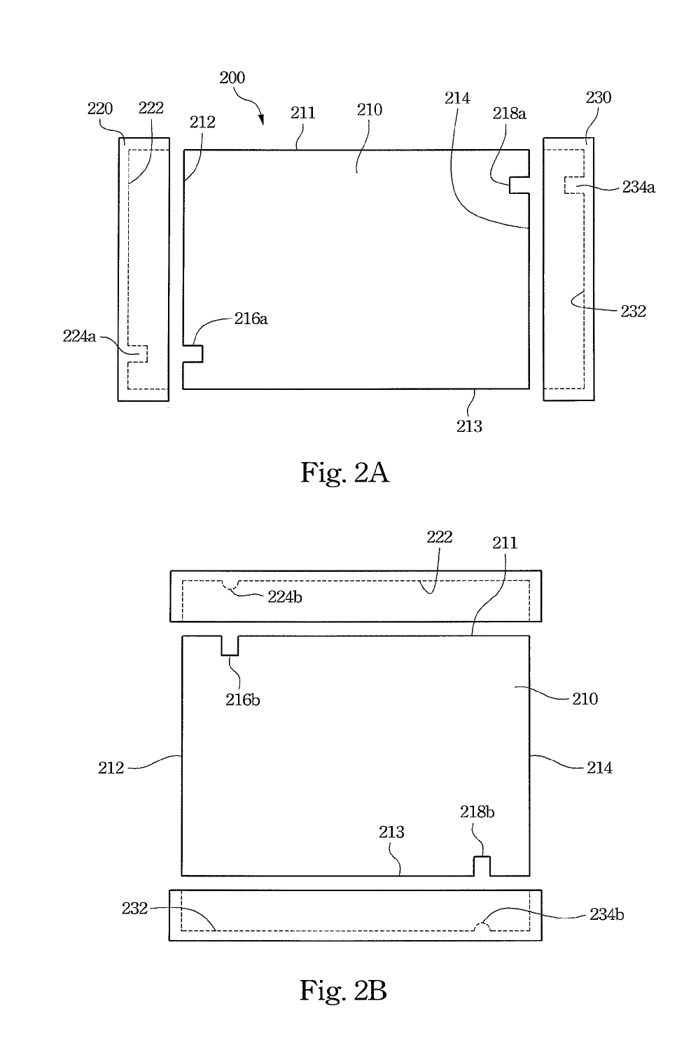

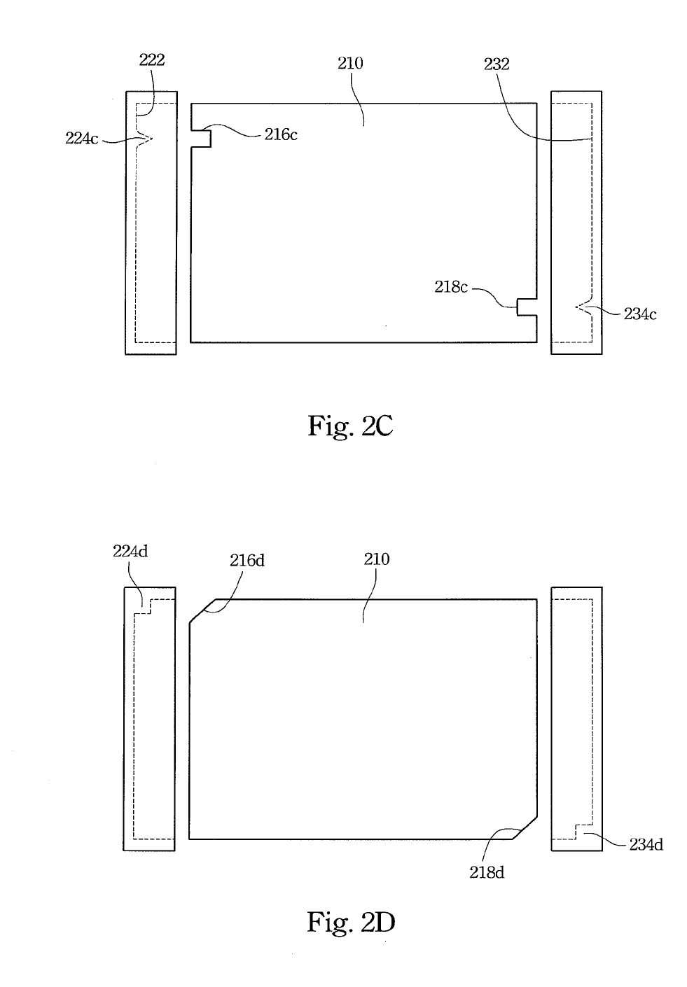

Refer to FIG. 2A to FIG. 2D. FIG. 2A to FIG. 2D illustrate schematic diagrams of different embodiments of the back light unit of the invention. The optical film 210 of the back light unit 200 has two opposite sides 212, 214, and two breaches 216, 218 are formed on the opposite sides 212, 214 respectively. The breaches 216, 218 are arranged at a different height of the sides 212, 214. The side frames 220, 230 include the fillisters 222, 232 respectively, and the optical film 210 is contained in the fillisters 222, 232. The blocks 224, 234 are disposed in the fillisters 222 and 232 respectively and correspond to the breaches 216, 218. The blocks 224 and 234 are disposed in the breaches 216 and 218 when the optical film 210 is fixed in the side frames 223, 230. The shape of the blocks 224 and 234, and the breaches 216 and 218 may not be limited, but the blocks 224 and 234 are designed to be disposed in the breaches 216 and 218.

The breaches 216 and 218 may be skew symmetrically formed on the opposite sides 212 and 214 but not at the same height. The side frames 220 and 230 in this embodiment may be fabricated with the same mold.

Refer to FIG. 2A. The breaches 216a and 218a may be formed on two short sides 212 and 214 of the optical film 210. The shape of the breaches 216a and 218a may be rectangular, and the shape of the blocks 224a and 234a may be the same rectangle. The blocks 224a and 234a may couple with the breaches 216a and 218a when the optical film 210 is fixed in the fillister 222 and 232. The different heights of the breaches 216a and 218a are defined along the short sides 212 and 214, i.e. the breaches 216a and breaches 218a would not be arranged on the same horizontal line. The breach 216a may be formed farther the long side 211, and the breach 218a may be formed nearer the long side 21.

Refer to FIG. 2B. The breaches 216b and 218b are formed on two long sides 212 and 214 of the optical film 210. The shape of the breaches 216b and 218b may be different from the shape of the blocks 224b and 234b. For example, the shape of the breaches 216b and 218b may be rectangular, and the shape of the blocks 224b and 234b may be an arc. The blocks 224b and 234b may touch the breaches 216b and 218b when the optical film 210 is fixed in the fillister 222 and 232. The different height of the breaches 216b and 218b are defined along the long sides 211 and 213, i.e. the breaches 216b and 218b would not be arranged on the same vertical line. The breach 216b may be formed farther to the short side 212, and the breach 218b may be formed near the short side 212.

Refer to FIG. 2C. The shape of the breaches 216c and 218c are different from the shape of the blocks 224c and 234c. The blocks 224c and 234c would not touch the breaches 216c and 218c when the optical film 210 is fixed in the fillister 222 and 232. The blocks 224c and 234c disposed in the fillister 222 and 232 would still interfere with the optical film 210 and the optical film 210 would bend if the optical film 210 were assembled upside down.

Refer to FIG. 2D. The breaches 216d and 218d may be formed on two diagonal corners of the optical film 210 respectively. The shape of the breaches 216d and 218d may be triangle. The shape of the blocks 224d and 234d may be rectangular.

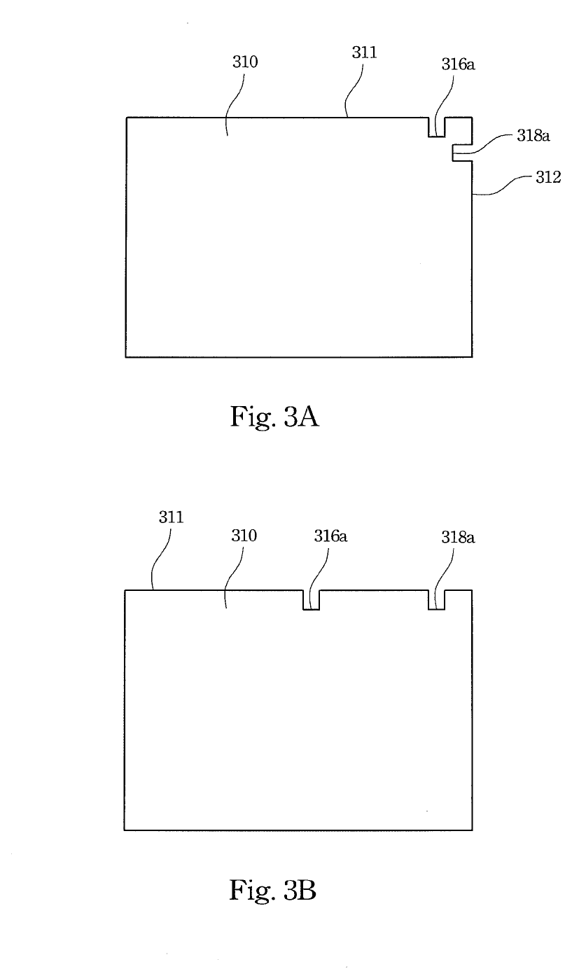

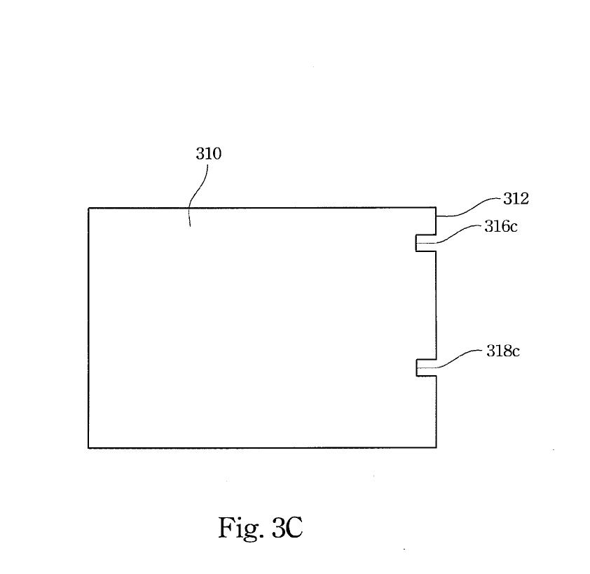

Refer to FIG. 3A to FIG. 3C. FIG. 3A to FIG. 3C illustrate schematic diagrams of different embodiments of the optical film of the back light unit of the invention. The breaches 316a and 318a may be formed on two adjacent sides 311 and 312 of the optical film 310, as shown in FIG. 3A. The breaches 316b and 318b may be formed on the same long side 311 of the optical film 310, as shown in FIG. 3B. The breaches 316c and 318c may be formed on the same short side 312 of the optical film 310. The blocks (not shown) corresponding to the breaches 316 and 318 of the above embodiments may be formed in the fillisters of two side frames or the fillister of one rectangular frame.

The blocks disposed in the fillisters are located in the breaches of the optical film when the optical film is assembled in the frame correctly. The blocks disposed in the fillisters would interfere with the sides of the optical film if the optical film were assembled upside down, and the optical film would bend and could not be assembled properly. The blocks disposed in the fillisters and the breaches formed on the optical film of the back light unit could prevent the optical film from upside down assembly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back light unit comprising:
an optical film comprising at least one side;
two breaches formed on at least one side with different heights respectively;
a frame comprising a fillister for containing the optical film in the frame; and
two blocks disposed in the fillister and disposed corresponding to the breaches respectively, wherein the blocks are located in the breaches when the optical film is fixed in the fillister.

2. The back light unit of claim 1, wherein the shape of the breaches is the same as the shape of the blocks, and the blocks couple with the breaches when the optical film is fixed in the fillister.

3. The back light unit of claim 1, wherein the shape of the breaches is different from the shape of the blocks, and the blocks touch the breaches when the optical film is fixed in the fillister.

4. The back light unit of claim 1, wherein the shape of the breaches is different from the shape of the blocks, and the blocks do not touch the breaches when the optical film is fixed in the fillister.

5. The back light unit of claim 1, wherein the optical film is selected from the group consisting of a light guide plate, a reflector, a diffuser, a prism sheet, and the combination thereof.

6. The back light unit of claim 1, wherein the optical film comprises two diagonal corners, and the breaches are formed on the diagonal corners respectively.

7. The back light unit of claim 1, wherein the optical film comprises two opposite sides, and the breaches are formed on the opposite sides respectively.

8. The back light unit of claim 7, wherein the breaches are skew symmetrically formed on the opposite sides of the optical film.

9. The back light unit of claim 7, wherein the opposite sides are two long sides of the optical film.

10. The back light unit of claim 7, wherein the different height of the breaches are defined along the long sides.

11. The back light unit of claim 7, wherein the opposite sides are two short sides of the optical film.

12. The back light unit of claim 11, wherein the different height of the breaches are defined along the short sides.

13. The back light unit of claim 1, wherein optical film comprises two adjacent sides, and the breaches are formed on the adjacent sides respectively.

14. The back light unit of claim 1, wherein the optical film comprises a long side, and the breaches are formed on long side.

15. The back light unit of claim 1, wherein the optical film comprises a short side, and the breaches are formed on the short side.

16. The back light unit of claim 1, wherein the shape of the breaches is selected from the group consisting of a triangle, a rectangle, an arc, a polygon, and the combination thereof.

17. The back light unit of claim 1, wherein the shape of the blocks is selected from the group consisting of a triangle, a rectangle, an arc, a polygon, and the combination thereof.

18. The back light unit of claim 1, wherein the back light unit is a bottom lighting back light unit.

19. The back light unit of claim 1, wherein the back light unit is a side-edge back light unit.
